(19) United States
(12) Patent Application Publication
(10) Pub. No.: US 2014/0136938 A1
(43) Pub. Date: May 15, 2014

(54) LIST MANAGEMENT IN A DOCUMENT MANAGEMENT SYSTEM

(71) Applicant: MICROSOFT CORPORATION, Redmond, WA (US)

(72) Inventors: Johnny S. Campbell, Renton, WA (US); Steven C. Tullis, Redmond, WA (US)

(73) Assignee: Microsoft Corporation, Redmond, WA (US)

(21) Appl. No.: 13/672,708

(22) Filed: Nov. 9, 2012

(51) Int. Cl. G06F 17/00; G06F 3/01

(52) U.S. Cl. 715/212; 715/751

(57) ABSTRACT

A document management system includes a list management application that manages one or more lists stored by the document management system. The list management application exposes list management functionality to users that access the lists in the document management system. The lists are stored as list management application files.

### BACKGROUND

Document management systems are currently in wide use. Current document management systems are computer systems that can be used to track and store electronic documents.

Some current systems can keep track of the different versions of a document modified by users that are in collaboration with one another. That is, different users can provide different modifications to a given document, and the document management system keeps track of all the different versions (such as by using history tracking) of the document. Some document management systems include a plurality of different computer programs used to create and manage electronic documents. The computer programs can include collaboration tools that allow a plurality of different users to collaborate, security programs that implement security and workflow and auditing programs that implement workflow and auditing features, among others. Of course, every document management system may not have all of these programs, and some document management systems can have additional or different programs as well.

Some current document management systems are used by enterprise organizations and may be included in customer relations management (CRM) systems, enterprise resource planning (ERP) systems, line-of-business (LOB) applications, or other business systems. In the business context, the document management systems are often used to manage business documents, such as sales orders, quotes, product information, etc.

Users of document management systems often have data stored on the document management systems in the form of lists. The lists can be visualized on webpages or in client applications, and allow users to add, modify, delete and organize data.

However, some users attempt to perform more detailed or complex analysis on the data in the list. Some mechanisms for doing this exist, but they are quite limited. They often call the user to export the list from the document management system into a list management application (such as a spreadsheet application) that is resident on the user's local machine. In this way, the user can perform the more detailed analysis or manipulation of the data using the list management application. However, this can lead to other problems. For instance, because the analysis is performed on a local spreadsheet application, there can be multiple different versions of the data in the list. One version can reside in the local spreadsheet application while the other resides on the document management system. Similarly, even if more complex calculations and analysis are performed on the list data on the local management application, the logic corresponding to those calculations and the detailed analysis does not follow the list itself, when it is transmitted back to the document management system. The detailed analysis logic can often become very important and as important as the list data itself. It is problematic to have to not only manage multiple versions of the list, but also multiple versions of the business logic used on the list data.

The discussion above is merely provided for general background information and is not intended to be used as an aid in determining the scope of the claimed subject matter.

### SUMMARY

A document management system includes a list management application that manages one or more lists stored by the document management system. The list management application exposes list management functionality to users that access the lists in the document management system. The lists are stored as list management application files.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative embodiment of a processing system.

FIG. 2 is a flow diagram illustrating one embodiment of the overall operation of the system shown in FIG. 1.

FIGS. 3A and 3B show illustrative user interface displays.

FIG. 4 is a block diagram of a document management system with a list management application deployed therein.

FIG. 5 is a block diagram showing the processing system of FIG. 1 in various architectures.

FIGS. 6-10 show various embodiments of mobile devices.

FIG. 11 is a block diagram of one illustrative computing environment.

### DETAILED DESCRIPTION

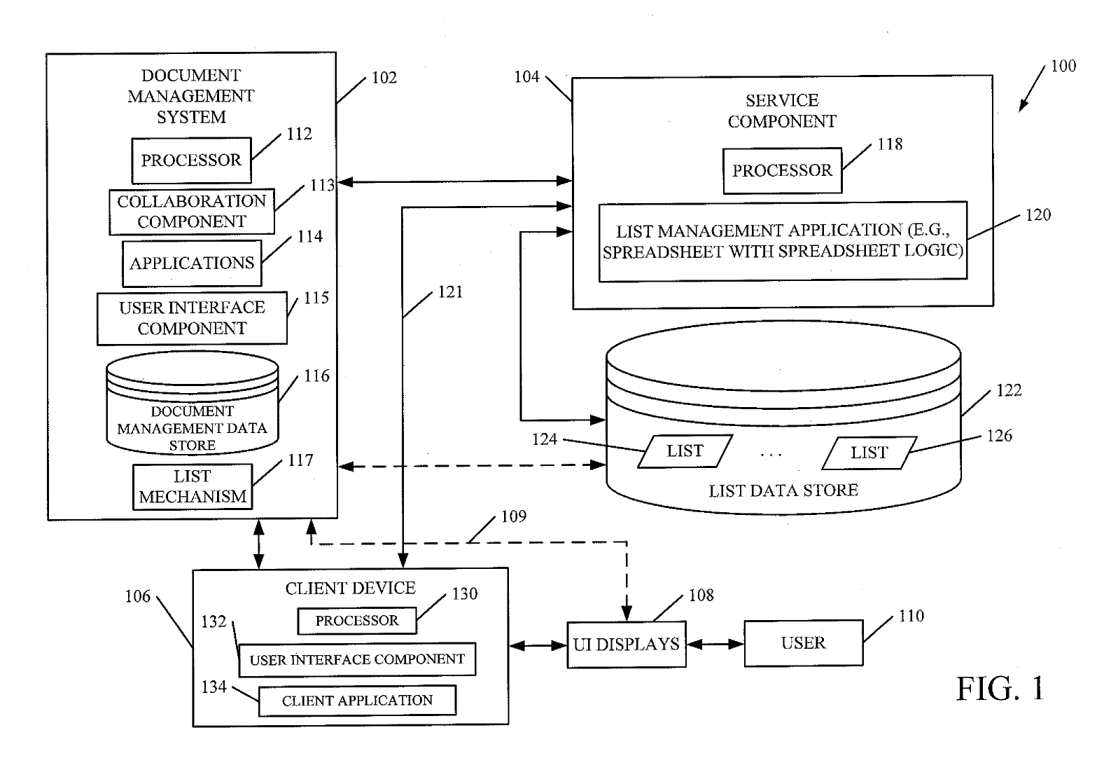

FIG. 1 is a block diagram of processing system 100. System 100 includes document management system 102 and service component 104. Document management system 102 is coupled to client device 106. Client device 106 illustratively generates user interface displays 108 for user 110. In the embodiment shown in FIG. 1, document management system 102 illustratively includes processor 112, collaboration component 113, applications 114, user interface component 115, document management data store 116, and list mechanism 117.

Processor 112 is illustratively a computer processor with associated memory and timing circuitry (not separately shown). It is illustratively a functional part of document management system 102 and facilitates the functionality of applications 114 and other components in document management system 102.

Document management data store 116 illustratively stores documents and other data for document management system 102. Applications 114 illustratively provide functions to manage documents. Applications 114 can include ERP systems, CRM systems, LOB systems, other data systems, or other applications used in document management system 102. User interface component 115, in one embodiment, generates user interface displays 108 that have user input mechanisms that receive user inputs so user 110 can access and manipulate system 102. While document management data store 116 is shown as a single data store, it could be multiple different data stores and they can be located remotely from system 102, or some of them can be local and others can be located remotely. Collaboration component 113 provides functionality so that a plurality of different users can collaborate on documents maintained by application 114.

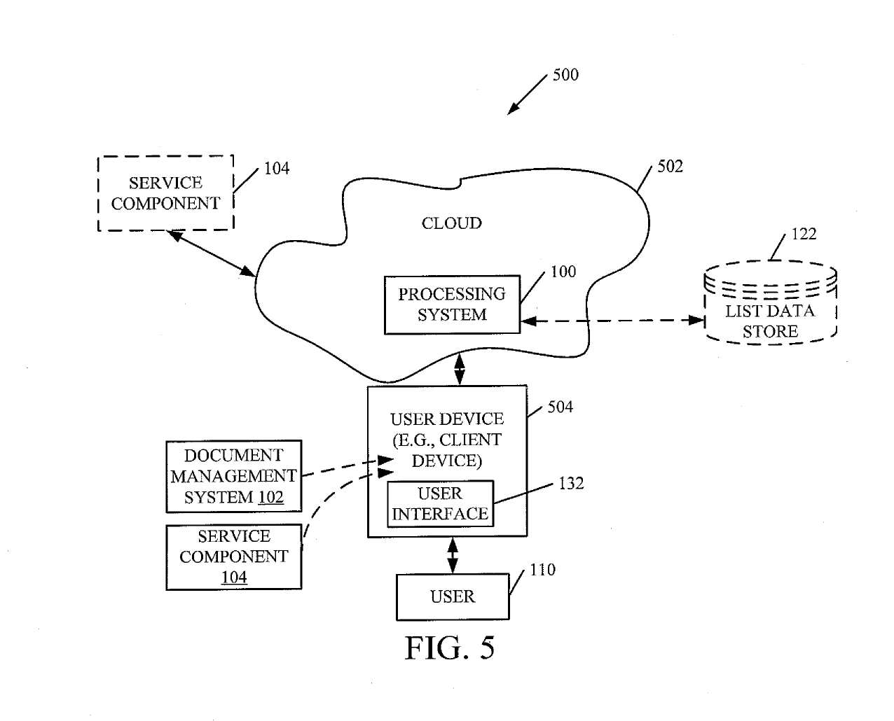

Document management system 102 illustratively accesses service component 104 to obtain services. Service component 104 can be located locally with respect to document management system 102 or remotely therefrom. System 102 can access component 104 through a network (such as a wide area network or a local area network) and service component 104 can be located in the cloud (described in greater detail below with respect to FIG. 5).

Service component 104 illustratively includes processor 118, list management application 120 and list data store 122. In one embodiment, processor 118 is a computer processor with associated memory and timing circuitry (not separately shown). Processor 118 is illustratively coupled to, and is illustratively a functional part of, component 104 and is coupled to and facilitates the functionality of list management application 120 and other components or items in component 104. List data store 122 illustratively stores a plurality of lists 124-126 that are managed by document management system 102. It will be noted that lists 124-126 could be stored on document management data store 116 or elsewhere, although they are shown in data store 122 on component 104 as one example. It should also be noted that data store 122 is shown as a single data store, but it could be multiple data stores as well. The data stores could be located remotely from component 104, or some can be located locally while others are located remotely. They can also be accessible by document management system 102. List management application 120 is illustratively an application that provides list management functionality to manage lists 124-126. The lists are illustratively used to store and display different types of data. Calendars and action items are two examples, but lists 124-126 can contain a wide variety of other types of data as well. The collection of information in a list can be shared with a team or other group of users, using collaboration component 113 in system 102. Lists 124-126 can be predefined lists or user definable. Component 104 can have templates for setting up lists or the lists can be generated from scratch.

The list management functionality allows users to add items to, and delete items from the list, to reorder items in the list, and to perform other functions as well. In one embodiment, list management application 120 is a spreadsheet application with associated spreadsheet logic that is used by spreadsheet applications to manipulate and analyze information in a spreadsheet. In the exemplary embodiment, lists 124-126 are list management application files for list management application 120. For the sake of the present discussion, lists 124-126 are spreadsheet files (i.e., spreadsheets), and stored as spreadsheets, although other implementations are contemplated herein as well.

List mechanism 117 provides user interface and other functionality to generate user interfaces with user input mechanisms that allow a user to generate and access lists 124-126. In one embodiment, the list mechanism 117 is separate from list management application 120. Mechanism 117 can allow the user to generate lists by accessing list templates or other predefined lists, or by creating the lists, themselves, in system 102. Once the lists are created, system 102 uses list management application 120 to perform the list management functions on the list content. This is described in greater detail below.

Client device 106 illustratively includes processor 130, user interface component 132 and client application 134. Processor 130, as with processors 112 and 118, is illustratively a computer processor with associated memory and timing circuitry (not separately shown). It is illustratively a functional part of device 106 and facilitates the functionality of component 132, application 134, and other items in client device 106. Also, while there are three processors shown in FIG. 1, there could be more processors with functionality divided among them, or fewer processors as well with functionality combined. These three processors are shown for the sake of example only.

Client device 106 can be for example, a “thick” device or a “thin” device. That is, application 134 can be a list management application client (e.g., a spreadsheet client) running locally on client device 106. Or, application 134 can be a browser connected to service component 104 and accessing list management application (e.g., spreadsheet application) 120. The latter is indicated by arrow 121. Other configurations are contemplated as well.

User interface component 132 illustratively generates user interface displays 108 with user input mechanisms. User 110 can illustratively provide inputs on the user input mechanisms in order to control and manipulate document management system 102.

Before describing the operation of system 100 in more detail, a brief overview will be provided for the sake of enhanced understanding. It is assumed that user 110 desires to create or access one of lists 124-126 through document management system 102. In that case, user 110 provides inputs through user interface displays 108 to control list mechanism 117 to create a new list or access an existing list. The user's interface display 108 can be originally generated at client device 106 (using component 132) or at system 102 (using components 115 and 117) or even by service component 104. Document management system 102 illustratively accesses service component 104, and specifically list management application 120. List management application 120 provides the list management services for lists used by document management system 102. User interface display 108 is provided to user 110 so that user 110 can perform list management functions using list management application 120. The list management functions are performed and the list can then be either copied as a new list in data store 122 or saved back, as the same (but modified) list in data store 122. Of course, the list could also be stored elsewhere, deleted or exported to other systems, or used in other ways as well.

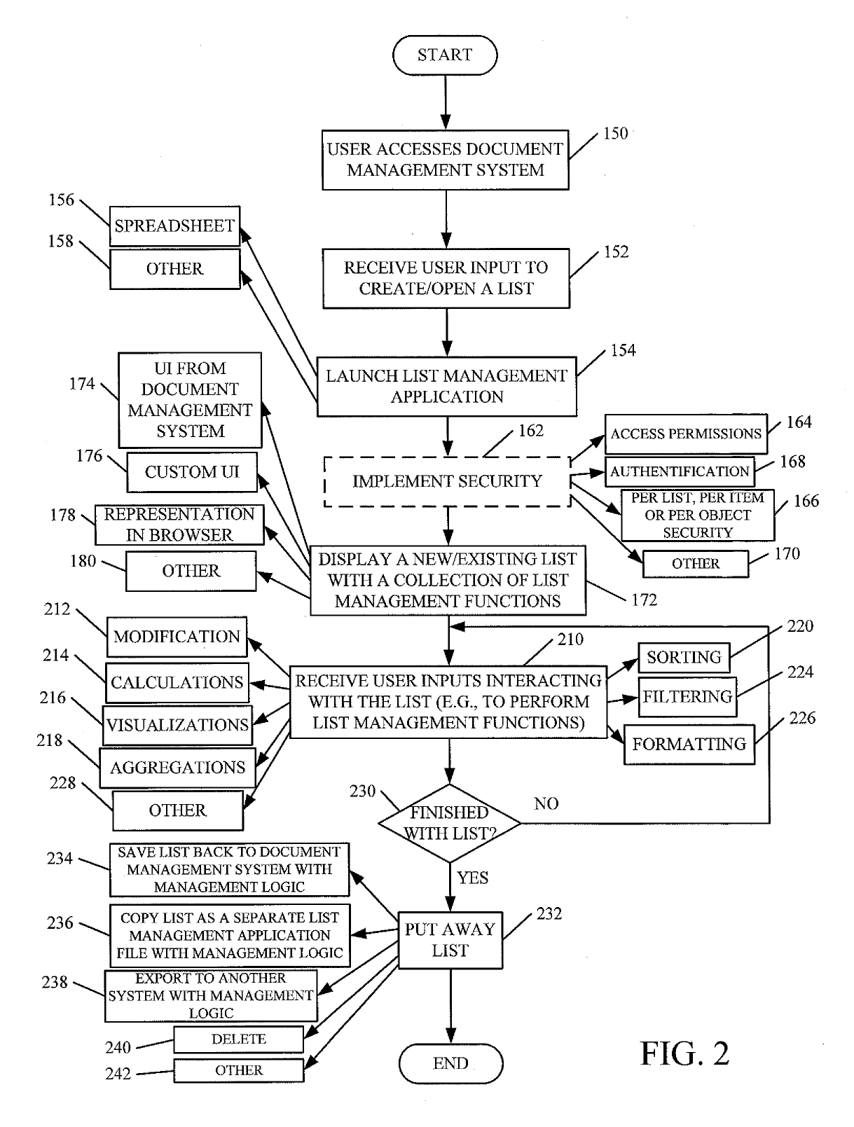

FIG. 2 is flow diagram illustrating one embodiment of the operation of system 100 in greater detail. FIGS. 1 and 2 will now be described in conjunction with one another. In one embodiment, user 110 first accesses document management system 102. This can be done in a variety of different ways. For instance, in one embodiment, user interface component 132 generates a user interface display 108 for user 110. User 110 can then provide user inputs through user input mechanisms on user interface displays 108. This can cause client application 134, (or a browser) for instance, to access document management system 102 or an application 114 on document management system 102. For example, the user 110 may wish to open an application in a customer resource management system in document management system 102. In any case, accessing document management system 102 is indicated by block 150 in FIG. 2. It will be appreciated that the user input mechanisms can be any of a wide variety of user input mechanisms, such as buttons, dropdown menus, navigable links, text boxes, other navigation elements or a wide variety of user input mechanisms. The user can provide inputs through these mechanisms in a wide variety of different ways as well. For instance, the user can use a point and click device such as a trackball or mouse. The user can also illustratively use a hardware or software keyboard or keypad, a microphone for receiving voice inputs, etc. In addition, where the display device that displays user interface displays 108 is a touch sensitive screen or other touch sensitive device, the user can provide user inputs using touch gestures with the user's finger, with a stylus, or otherwise.

User interface component 132 then illustratively provides a user interface display 108 that allows a user to manipulate or control document management system 102. In one exemplary embodiment, the user illustratively provides an input indicating that the user wishes to either create a new list or open an existing list using list mechanism 117 in document management system 102. Receiving the user inputs to create or open a list is indicated by block 152 in FIG. 2.

In response, document management system 102 (e.g., list mechanism 117) illustratively accesses service component 104 and launches list management application 120. This is indicated by block 154 in FIG. 2. It will be noted that list management application 120 can be a variety of different applications. In one embodiment, application 120 is a spreadsheet application with spreadsheet logic, as indicated by block 156 in FIG. 2. Of course, other list management applications 158 can be used as well.

List management application 120 then either generates a new list or accesses list data store 122 in order to display an existing list. In doing so, list management application 120 can implement various security measures. For instance, it may be that data contained in certain lists 124-126 may contain sensitive information which can only be accessed by certain persons. Implementing the security is indicated by block 160 in FIG. 2. Block 160 is shown in phantom, because it is optional. Also, implementing security can be done by application 120, itself, or by a separate security component. The present description proceeds with application 120 implementing security, but this is exemplary only.

In order to implement security, list management application 120 can access permissions as indicated by block 164. Permissions can be contained in data store 122, or elsewhere. In one embodiment, the permissions provide role-based access to the information in lists 124-126. In such an embodiment, each user is illustratively assigned a role. When the user wishes to access a list, list management application 120 can provide the access to the list based on the user's role. If the user is a human resources person, for instance, the user may have access to personnel information in various lists (e.g. salary information, personal records, etc.). However, if the user is a sales manager, then the user may only have access to sales data in a given list, and not to personnel information. These are examples only and accessing permissions to implement other types of security can be used as well.

In one embodiment, list management application 120 employs per-list, per-item or per-object security as indicated by block 166 in FIG. 2. That is, application 120 can provide access to, or deny access to, an entire list based on the security permissions. Application 120 can also provide access to only certain items or objects in a given list based upon the implemented security as well. As one example, where the list is a spreadsheet, the list management application (the spreadsheet application) implements per-object security. An object can be any spreadsheet object such as a table, a single cell, a chart, a pivot table, a named range, etc.

In another embodiment, application 120 also provides authentication procedures 168. The authentication procedures allow user 110 to authenticate himself or herself to the system and security is implemented based upon the authentication information. Of course, other security measures 170 can be implemented as well, and those described are for the sake of example only.

Once list management application 120 has implemented security (if it does), it generates a user interface display (such as through document management system 102 and client device 106, or more directly as indicated by arrow 109 or from component 104, itself) that displays the new or existing list along with a collection of list management functions. Creating the new list and displaying it, or displaying the existing list (both of which include the collection of list management functions) is indicated by block 172 in FIG. 2.

The display can be generated in a variety of different ways. For instance, the display can be provided through document management system 102, in which case the user interface display appears as though it is generated by document management system 102, but includes list management functionality user input mechanisms so the user can manage the displayed list. This is indicated by block 174.

Of course, the user interface display that displays the list can also be a customized user interface display generated specifically by service component 104 (and list management application 120) so that it takes on a different appearance from those natively provided by document management system 102. The custom user interface display is indicated by block 176 in FIG. 2.

Where a client application 134 is a browser, the browser can use user interface component 132 on client device 106 in order to generate UI displays 108. This is indicated by block 178 in FIG. 2.

Of course, the user interface display that shows the list and the collection of list management functions can be generated in other ways as well. This is indicated by block 180 in FIG. 2.

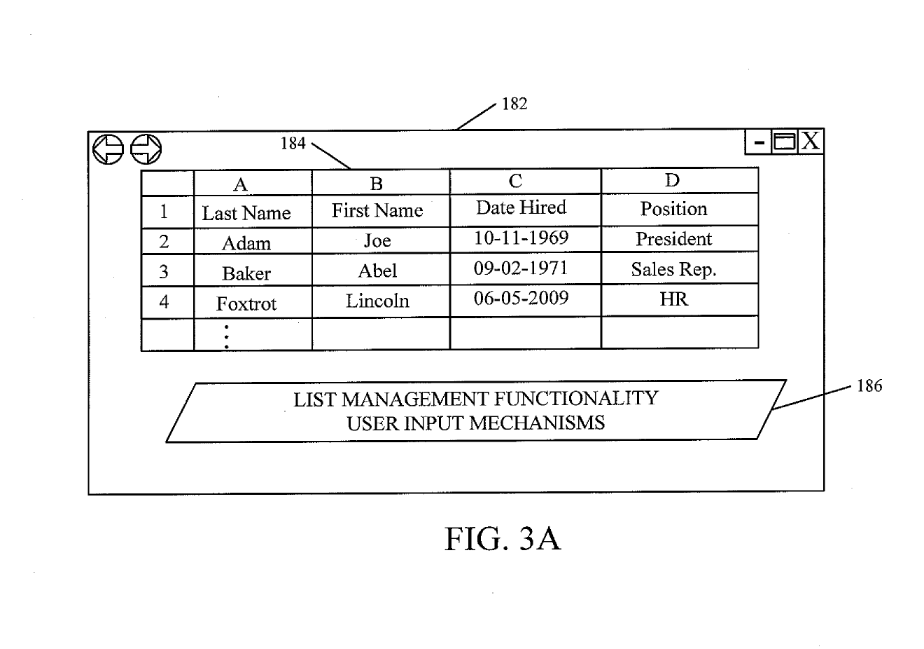

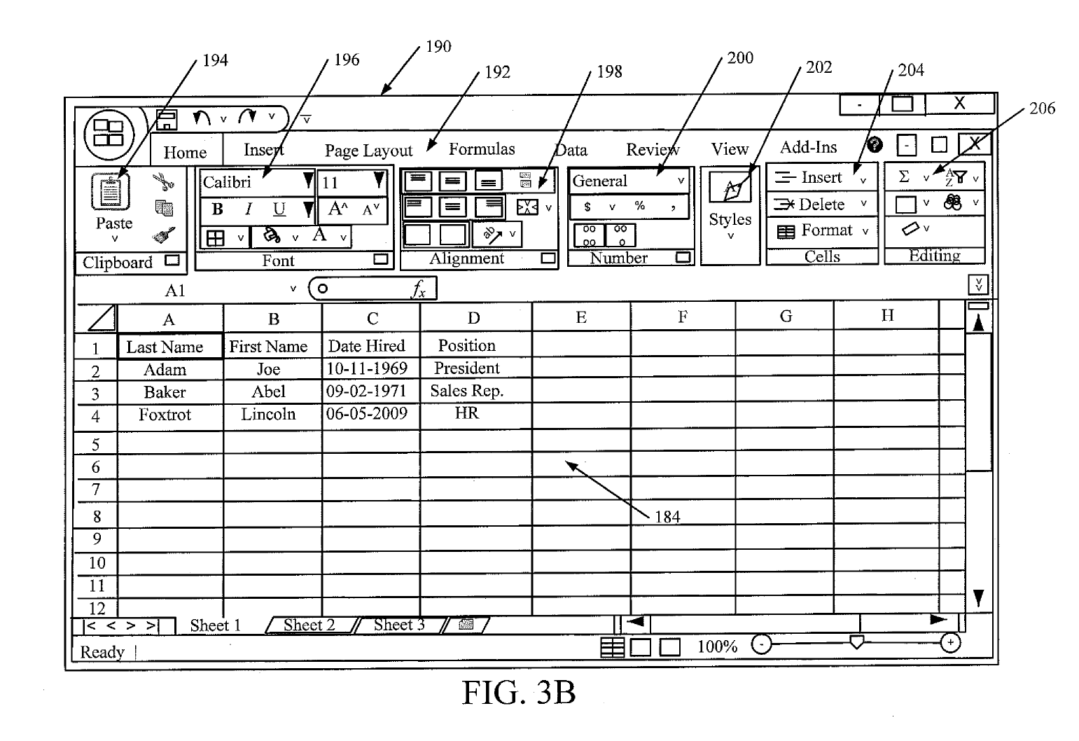

In any case, system 100 generates a user interface display 108 for user 110 that includes the list (such as list 124), along with user input mechanisms that allow user 110 to perform list management functions enabled by list management application 120. FIG. 3A shows one exemplary user interface display 182 that includes a grid of cells 184 that includes the list content. The cells include list items arranged in rows and columns. The columns have titles that include “Last Name”, “First Name”, “Date Hired”, and “Position”. The “Last Name” column has entries that include last names. The “First Name” column has entries that include first names. The “Date Hired” column has entries that include dates, and the “Position” column has entries that include the position held by the individual identified in the previous columns. User interface display 182 also illustratively includes list management functionality user input mechanisms 186. These are shown as block 186, but they could take a wide variety of different forms. For instance, they could be buttons, dropdown menus, navigable links, text boxes, add or delete mechanisms, reordering mechanisms and a wide variety of other mechanisms that can be manipulated by user 110 through user interface display 182.

FIG. 3B shows another, more specific, example of a user interface display that displays the list content 184 shown in FIG. 3A. FIG. 3B is one example where list management application 120 is a spreadsheet application. User interface display 190 shows a display of a spreadsheet file that contains the list content 184 shown in FIG. 3A in various rows and columns. In FIG. 3B, the list management functionality user input mechanisms are represented by a variety of different user input mechanisms. They can be used to perform spreadsheet functions on the list content using spreadsheet logic. The spreadsheet functions are the functions that can be performed on the list content using the spreadsheet application. The spreadsheet logic is the underlying logic used to perform the spreadsheet functions. For instance, the user input mechanisms can include a set of tabs 192 that allow the user to navigate to a homepage, to a layout page, to create tables or charts or to insert art or formulas or to add or view data, or to review information. User input mechanisms can also include a set of edit user input mechanisms 194 that allow the user to edit content 184. Similarly, the user input mechanisms 186 can include a set of font user input mechanisms 196 that allow user 110 to change or otherwise manipulate the font in list content 184. User input mechanisms 186 can also include a set of alignment user input mechanisms 198 that allow the user to change the alignment of the text in the cells in content 184. User input mechanisms 188 can also include number user input mechanisms 200, format user input mechanisms 202, cell user input mechanisms 204 and theme user input mechanisms 206. User input mechanisms 200 allow the user to change the numbering scheme in content 184. Format user input mechanisms 202 allow the user to apply conditional formatting or change styles of the content 184. Cell user input mechanisms 204 allow the user to insert cells, delete cells, or change the format of the cells, in content 184. Theme user input mechanisms 206 allow the user to apply various display themes to the content 184. Of course, this is only an exemplary set of list management functions (e.g., spreadsheet functions) that can be provided by list management application 120 (e.g., spreadsheet application) on user interface display 190.

In any case, once system 100 has generated the user interface display with the collection of list management functions, list management application 120 receives user inputs interacting with the list. For example, user 110 can provide inputs on the user input mechanisms in order to perform list management functions. This is indicated by block 210 in FIG. 2. The list management functions, as described above with respect to FIGS. 3A and 3B, can take a wide variety of different forms. For instance, they can include modifying the list content 184 by making modifications 212. They can include performing calculations or other analysis on the content 184, such as by setting up formulas to perform various calculations or other analysis. This is indicated by block 214. They can include generating different visualizations of the list content, such as charts, pivot tables, graphs, or other visualizations 216. The functions can include generating aggregations of list content 184, as indicated by block 218. They can include sorting functions 220, filtering functions 224, formatting functions 226, or other list management functions 228.

List management application 120 then determines whether user 110 is finished with the list being displayed. This is indicated by block 230 in FIG. 2. This can be done in a variety of different ways as well. For instance, the user can provide a suitable user input through a user input mechanism indicating that the user is finished and that the list is to be saved or deleted or otherwise indicating that the user is finished with the list. Of course, if the user is not finished, list management application 120 continues to perform the list management functions input by the user.

If the user 110 is finished with the list, then document management system 102 accesses server component 104 so that list management application 120 can put away the list in the desired fashion. This is indicated by block 232 in FIG. 2. This can also be done in a variety of different ways. For instance, list management application 120 can save the list 124 back to list data store 122 or to document management data store 116 in document management system 102. This is indicated by block 234. Similarly, list management application 120 can copy the list as a separate list management application file and store it in either data store 122 or data store 116 or another data store. This is indicated by block 236 in FIG. 2. In addition, application 120 can export the list to another system (such as for printing, to a word processing system, to another document management system, etc.). This is indicated by block 238 in FIG. 2. In any of these cases, the stored or exported list illustratively has, along with it, the list management logic used to perform any list management functions. For instance, if the document management system is a business system, if the list is a spreadsheet and if the user used a formula (e.g., business logic) to analyze data in the spreadsheet (e.g., to aggregate data, perform a calculation and show the result), then the formula is stored or exported as part of the list (the spreadsheet). The same is true for other logic used to perform list management functions or to implement business logic. This helps to avoid problems encountered when multiple different versions of business logic or other logic are used on the list data. Of course, application 120 can also delete the list, if indicated by user 110. This is indicated by block 240. Application 120 can put away the list or otherwise dispose of the list in other ways as well, and this is indicated by block 242.

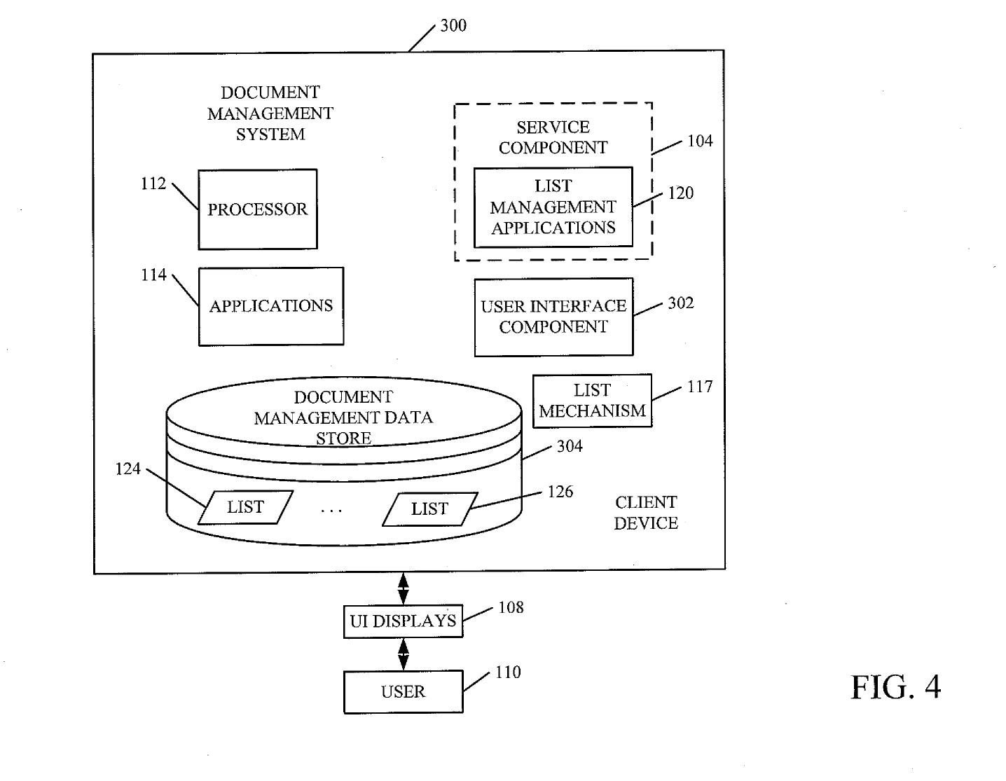

FIG. 4 shows yet another embodiment of a document management system 300. Document management system 300 is similar to document management system 102, and similar items are similarly numbered. However, in the embodiment shown in FIG. 4, document management system 300 has list management application 120 deployed as part of document management system 300. It can be seen that list management application 120 can be deployed as part of service component 104 within system 300, or it can simply be provided by itself, in document management system 300.

In the embodiment shown in FIG. 4, document management system 300 includes document management data store 304 which stores lists 124-126. Therefore, they are not stored in a separate server component 104 as shown in FIG. 1. Document management system 300 also includes user interface component 302 that generates user interface displays 108 for user 110. In the embodiment shown in FIG. 4, the user interface displays 108 allow user 110 to interact with lists 124-126, and list management application 120 provides the list management functionality for lists 124-126. The user interface displays 108 can again be generated by list management application 120, directly. For instance, if list management application 120 is a spreadsheet application, the user interface displays that allow user 110 to manage lists 124-126 can be generated directly by the spreadsheet application. However, the user interface displays can also be provided by document management system 300 or other applications 114 within document management system 300. In that case, the system or application that generates the displays calls list management application 120 to execute list management functions on the list. Of course, the displays 108 can also be generated in a browser or in another way as well.

In one embodiment, list management application 120 simply facilitates the list management functions. Therefore, list mechanism 117 or another application or component generates and displays the list to the user and receives user inputs to manage the list. List mechanism 117 (or the other application or component) then calls application 120 and provides the list and the user inputs to application 120. Application 120, in turn, performs the list management functions represented by the user inputs on the list and returns the modified list (the list as modified based on the user inputs) for presentation to the user.

FIG. 5 is a block diagram of system 100, shown in FIG. 1, except that it is disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 1 and they are similarly numbered. FIG. 5 specifically shows that system 100 is located in cloud 502 (which can be public, private, or a combination where portions are public while others are private). Therefore, user 110 uses a user device 504 (which can be client device 106) to access those systems through cloud 502.

FIG. 5 also depicts another embodiment of a cloud architecture. FIG. 5 shows that it is also contemplated that some elements of system 100 are disposed in cloud 502 while others are not. By way of example, data store 122 can be disposed outside of cloud 502, and accessed through cloud 502. In another embodiment, service component 104 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

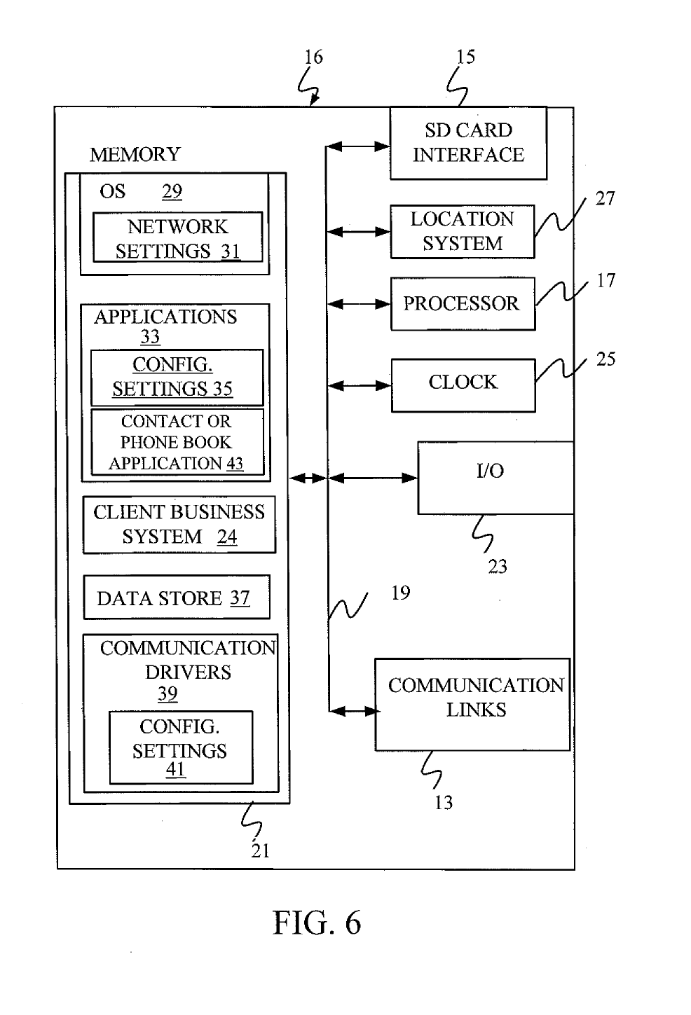

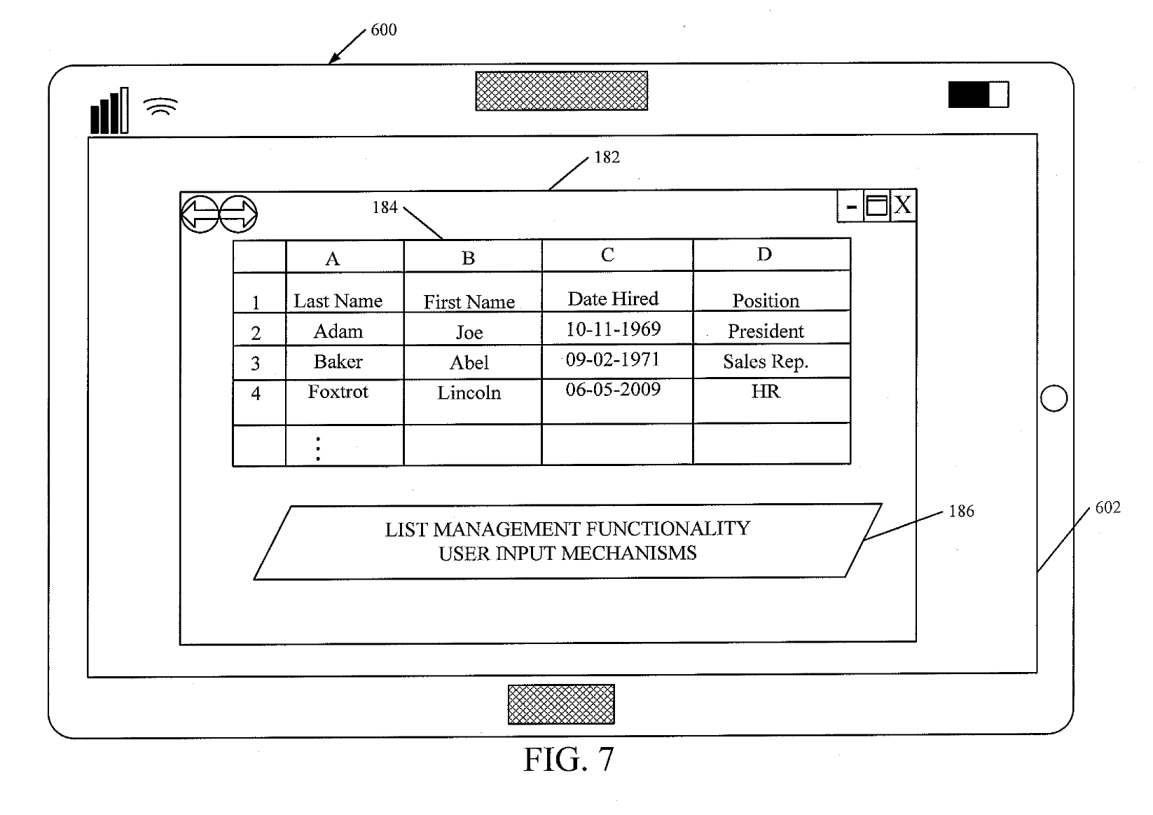

FIG. 6 is a simplified block diagram of one illustrative embodiment of a handheld or mobile computing device that can be used as a user's or client's hand held device 16, in which the present system (or parts of it) can be deployed. FIGS. 7-10 are examples of handheld or mobile devices.

FIG. 6 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processor 130 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data stores 116 or 122, for example, can reside in memory 21. Similarly, device 16 can have a client business system 24 (which can be client application 134 or another system) which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

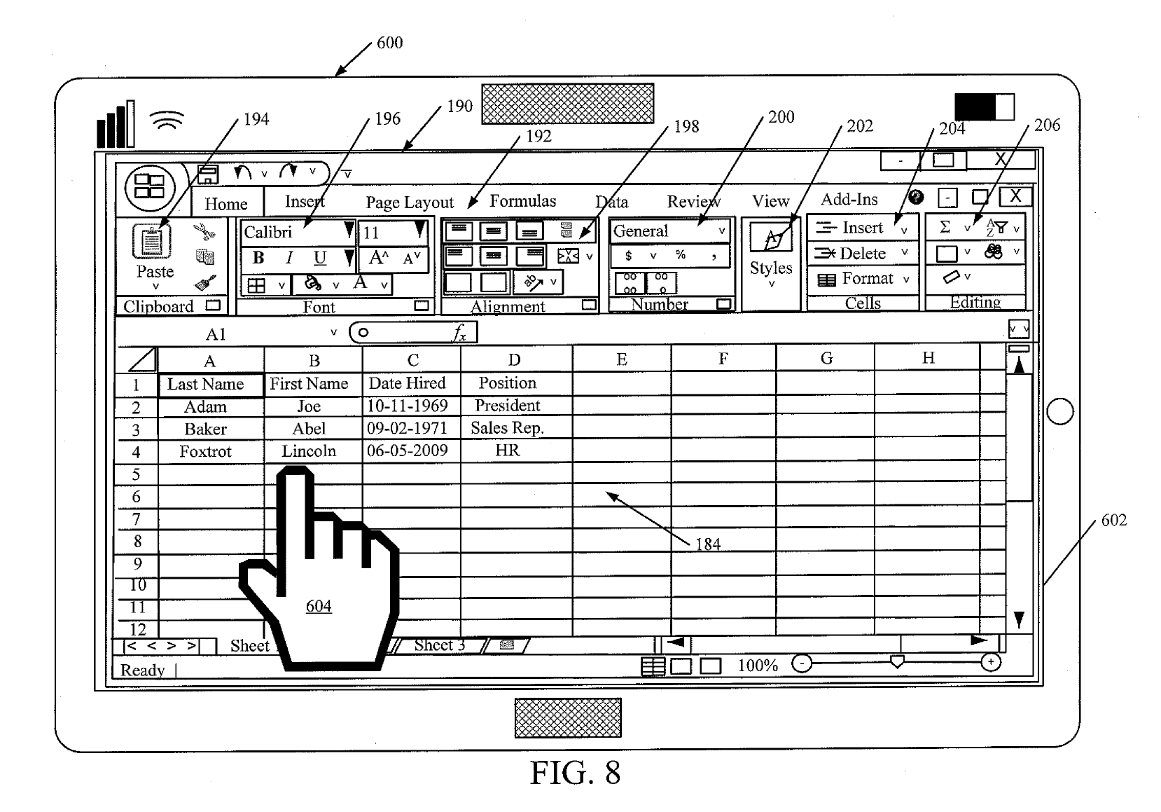

FIGS. 7 and 8 show one embodiment in which device 16 is a tablet computer 600. In FIG. 7, computer 600 is shown with user interface display 184 displayed on the display screen 602. FIG. 8 shows computer 600 with user interface display 190 displayed on display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

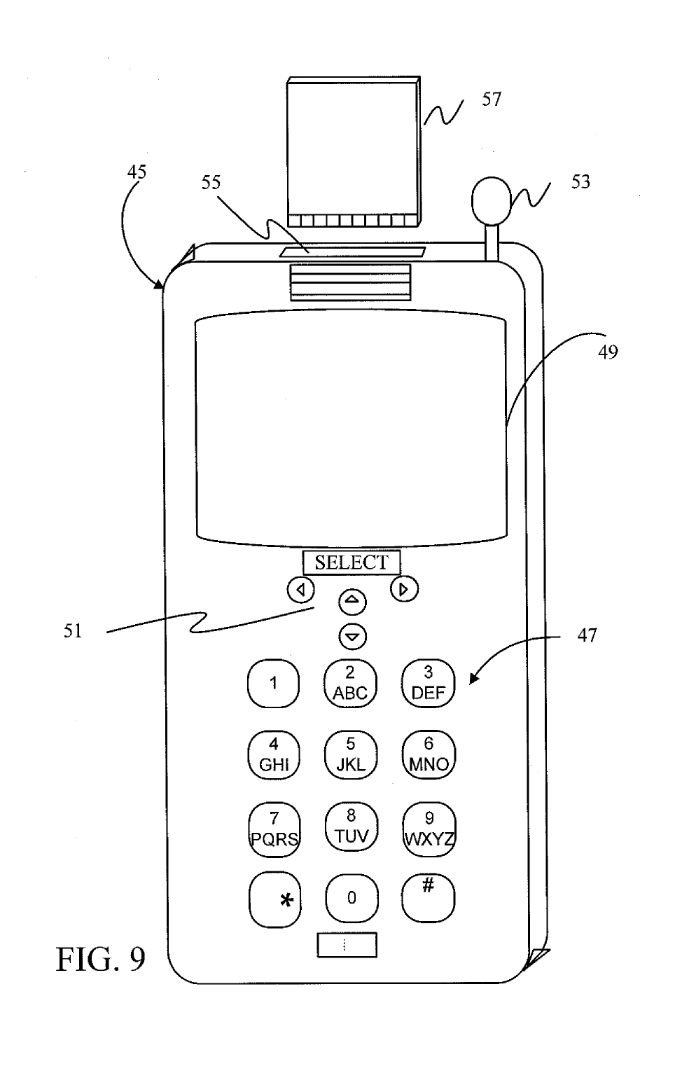

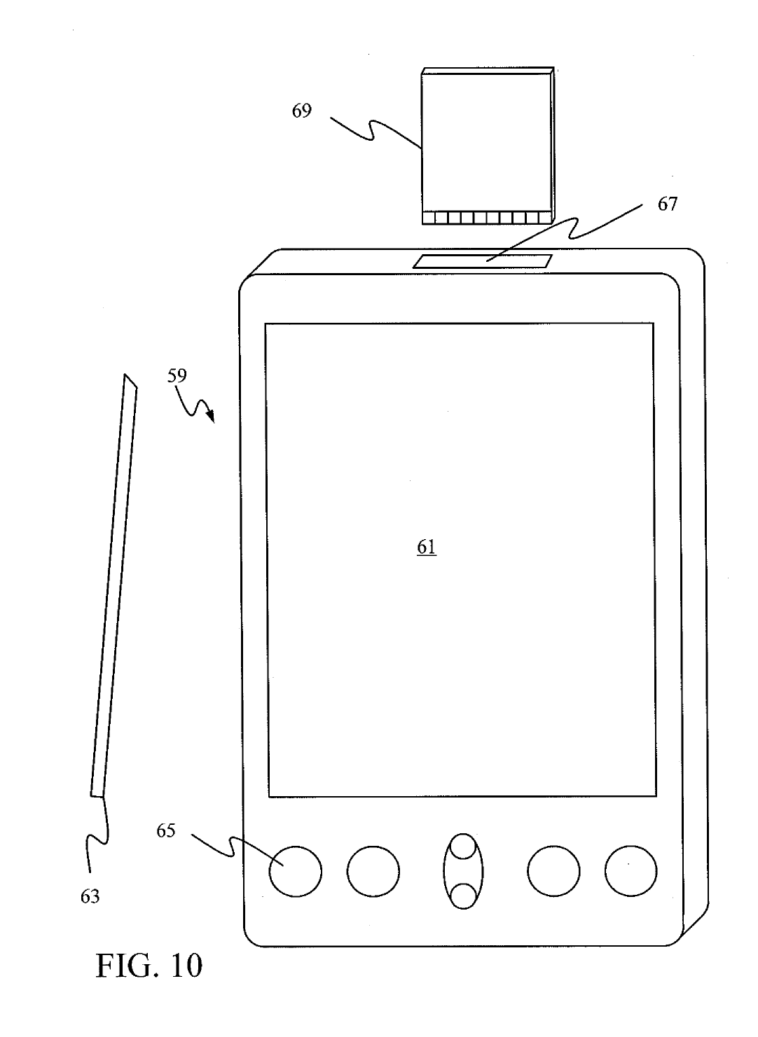

FIGS. 9 and 10 provide additional examples of devices 16 that can be used, although others can be used as well. In FIG. 9, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 10 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

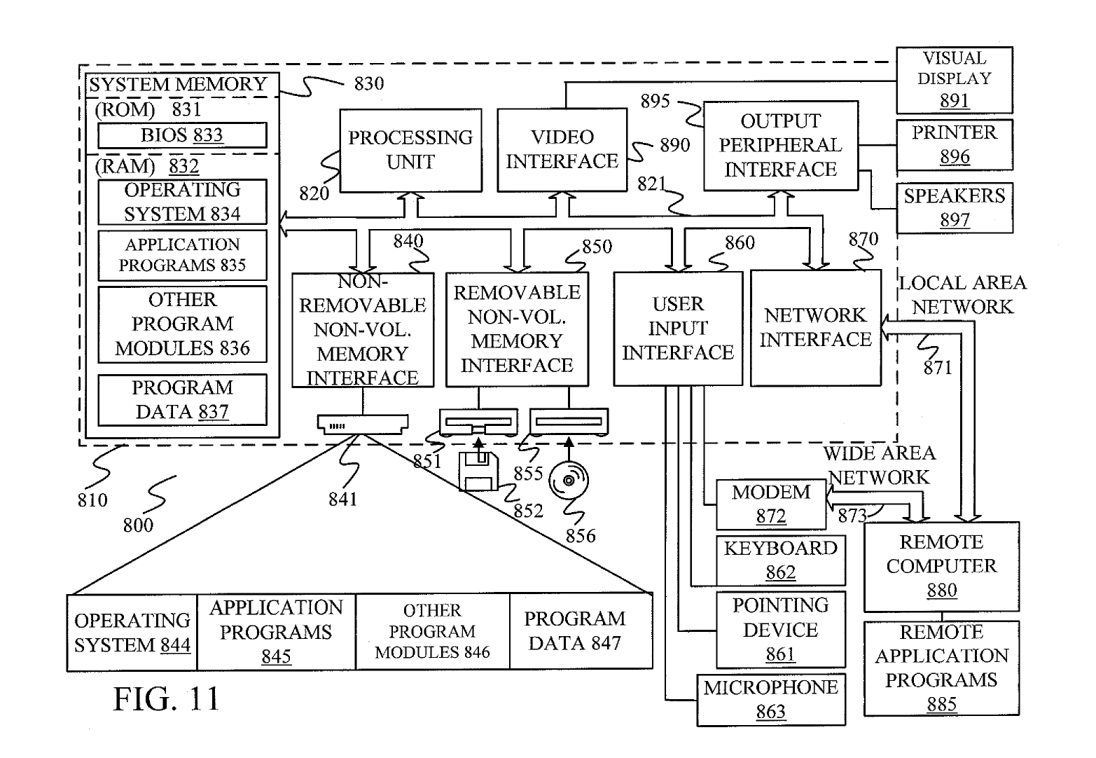

FIG. 11 is one embodiment of a computing environment in which system 100 (for example) can be deployed. With reference to FIG. 11, an exemplary system for implementing some embodiments includes a general-purpose computing device in the form of a computer 810. Components of computer 810 may include, but are not limited to, a processing unit 820 (which can comprise one or more of processors 112, 118 and 130), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 11.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 11 illustrates operating system 834, application programs 835, other program modules 836, and program data 837.

The computer 810 may also include other removable/non-removable volatile/nonvolatile computer storage media. By way of example only, FIG. 11 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 11, provide storage of computer readable instructions, data structures, program modules and other data for the computer 810. In FIG. 11, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 11 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 11 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Also, while multiple embodiments are shown and described, the features elements and components of the various embodiments can be combined in different ways with one another. This is contemplated herein.

What is claimed is:

1. A computer-implemented method of managing list content, comprising:
receiving, at a document management system, a list generation user input identifying a list to be generated;
generating the list as a list management application file based on the list generation user input;
displaying list content in the list management application file;
displaying list management user input mechanisms that receive list management user inputs; and
performing list management functions on the list content, based on the list management user inputs, using the list management application.

2. The computer-implemented method of claim 1 wherein generating the list comprises:
generating the list as a spreadsheet.

3. The computer-implemented method of claim 1 wherein performing list management functions comprises:
performing spreadsheet functions on the list content using spreadsheet logic.

4. The computer-implemented method of claim 3 and further comprising:
storing the list as a spreadsheet along with the spreadsheet logic.

5. The computer-implemented method of claim 3 wherein performing spreadsheet functions comprises:
generating spreadsheet visualizations of the list content.

6. The computer-implemented method of claim 1 wherein performing list management functions comprises:
accessing the list management application on a service component.

7. The computer-implemented method of claim 6 wherein accessing the list management application comprises:
sending the list and the list management user inputs to the list management application on the service component; and
receiving the list, with the list management functions performed thereon, from the service component.

8. The computer-implemented method of claim 1 wherein displaying the list content and displaying the list management functions comprise:
generating a user interface display with the list management application.

9. The computer-implemented method of claim 1 wherein displaying the list content and displaying the list management functions comprise:
generating a user interface display with the document management system.

10. The computer-implemented method of claim 1 wherein displaying the list content and displaying the list management functions comprise:
generating a user interface display with a browser on a client device.

11. The computer-implemented method of claim 1 and further comprising:
receiving a user list request input requesting an identified list;
obtaining the identified list; and
displaying list content in the identified list along with the list management user input mechanisms.

12. The computer-implemented method of claim 3 and further comprising:
exporting the list as a spreadsheet along with the spreadsheet logic.

13. The computer-implemented method of claim 7 and further comprising:
exporting the list as a spreadsheet for storage on the service component.

14. The computer-implemented method of claim 7 and further comprising:
saving the list as a spreadsheet on the document management system.

15. A document management system, comprising:
a document management application that performs document management functions on documents in the document management system;
a list management application that performs list management functions on list content in a list maintained as a list management application file;
a collaboration component that generates user interface displays with user input mechanisms that receive user inputs to collaborate on generating the list content; and
a computer processor that is a functional part of the document management system and activated by the document management application and the collaboration component to facilitate performing the document management functions and collaboration on generating the list content.

16. The document management system of claim 15 and further comprising:
a list mechanism, separate from the list management application, that provides list generation user input mechanisms receiving list generation user inputs to generate the list.

17. The document management system of claim 16 and further comprising:
a service component that includes the list management application.

18. The document management system of claim 17 and further comprising:
a list data store, that stores the list, disposed on the service component.

19. The document management system of claim 16 wherein the document management application comprises a business data application.

20. A computer readable storage medium, storing computer readable instructions which, when executed by a computer, cause the computer to perform steps comprising:
receiving, at a document management system, a list generation user input identifying a list to be generated;
generating the list as a list management application file based on the list generation user input;
displaying list content in the list management application file;
displaying list management user input mechanisms that receive list management user inputs; and
performing list management functions on the list content, based on the list management user inputs, using the list management application, by sending the list and the list management user inputs to the list management application on a service component, and receiving the list, with the list management functions performed thereon, from the service component.
